(19) United States
(12) Patent Application Publication
(10) Pub. No.: US 2024/0361976 A1
(43) Pub. Date: Oct. 31, 2024

(54) Audio Output Method And System

(71) Applicant: Sony Interactive Entertainment Europe Limited, London (GB)

(72) Inventors: Alan Murphy, London (GB); Phillip Cockram, London (GB)

(73) Assignee: Sony Interactive Entertainment Europe Limited, London (GB)

(21) Appl. No.: 18/647,606

(22) Filed: Apr. 26, 2024

(30) Foreign Application Priority Data
Apr. 27, 2023 (GB) GB2306259.9

(51) Int. Cl. G06F 3/16; A63F 13/54; A63F 13/87; H04R 3/04

(52) U.S. Cl. CPC G06F 3/165; A63F 13/54; H04R 3/04; A63F 13/87

(57) ABSTRACT

A method of generating audio output by a video gaming system is provided, the method comprising: obtaining one or more properties of an audio output device connected to the video gaming system; generating an adapted audio output for the audio output device by selecting, according to selection criteria, a subset of the audio components based on the obtained properties of the audio output device; and outputting only the selected audio components.

### CROSS-REFERENCE TO RELATED APPLICATION

The present application claims priority from United Kingdom Patent Application No. GB 2306259.9, filed Apr. 27, 2023, the disclosure of which is hereby incorporated herein by reference.

### FIELD OF THE INVENTION

The present invention relates to a method of generating audio output by a video gaming system.

### BACKGROUND

Modern video gaming systems provide an immersive entertainment experience to a user through the reproduction of sophisticated entertainment content using ever increasingly powerful hardware. To supplement the visual output that such systems can reproduce, high complexity audio output is generated to provide a realistic reproduction of sounds in the environment. Users of such systems can choose from a wide variety of audio output devices to listen to the audio output, each having different sound reproduction qualities and capabilities.

Audio content having a high audio complexity, for example a having high number of simultaneous audio components and/or a frequency composition containing frequencies approaching the extremes of the audible frequency range may in some cases be problematic to playback. Depending on the audio output device that a user is currently using to listen to the audio output, the audio output device may not be able to reproduce all components of the audio output effectively. For instance, background sounds may not be reproduced effectively on lower end audio output devices such as smartphones and other handheld devices.

Attempting to reproduce high complexity audio content on low quality audio output devices can cause a number of audio components in the audio output to be reproduced having poor quality, distortion or in some cases being made inaudible. Furthermore, in addition to the potentially multiple audio components originating from in-game sources, audio components such as voice chat may also be outputted simultaneously to the audio output device, thus further increasing the reproduction requirements of the audio output device.

In some current technologies, in-game audio components are assigned a priority value during game development such that audio components which are deemed important can take precedence when generating an audio output. For example, a subset of in-game audio components having a priority value above a threshold may be included in an audio output. However, the criteria used to determine if audio components of a given priority level are included in an audio output are typically based on the content within the game (e.g., dialogue, status of the player) and do not necessarily take into account perceived quality of the output.

Therefore, despite the assignment of priority values and optional removal of audio components, some audio components in an audio output may still be reproduced ineffectively by lower quality audio output devices. Furthermore, in some scenarios, audio components with the highest priority values may have audio characteristics which mean they will not be well reproduced by the audio output device.

Accordingly, there exists a need for a solution to mitigate at least some of the problems associated with the output of highly detailed audio in video game systems.

### SUMMARY

In a first aspect of the invention there is provided a method of generating audio output by a video gaming system, wherein the video gaming system is configured to output an audio stream comprising a plurality of audio components, the method comprising: obtaining one or more properties of an audio output device connected to the video gaming system; generating an adapted audio output for the audio output device by selecting, according to selection criteria, a subset of the audio components based on the obtained properties of the audio output device; and outputting only the selected audio components.

By generating an adapted audio output comprising a subset of the audio components based on the obtained properties of the audio output device, the adapted audio output can be reliably reproduced by the audio output device. This provides, for a given audio output device capability, the best overall auditory experience to the user as it prevents poor quality or distorted audio from distracting the user or masking other sounds.

“Audio components” typically relate to audio assets originating from sources such as in-game sound effects and other diegetic sounds, in-game music, other non-diegetic sounds, and overlayed sounds such as voice chat. An “audio asset” may refer to an individual piece of audible content such as a piece or snippet of music, a sound effect, a voiceover, or a piece of ambient audio, each of which may be output by the video gaming system during gameplay. Typically, each audio asset is provided as an individual audio file, usually as part of game data stored on the video gaming system or in storage accessible by the video gaming system during gameplay. In generating audio output, a video gaming system typically loads stored audio components (e.g. audio assets) as audio data files into a processing unit of the video gaming system where they are then processed by the processing unit to generate audio output. In some examples, selecting a subset of audio components may therefore involve selecting a particular subset of audio files to load into the processing unit of the video gaming system to generate audio output.

In addition to stored audio files forming part of the game data, an “audio asset” may also refer to a piece of audible content that is overlayed during gameplay but may not be directly associated with the gameplay or stored as part of the game data. An example of this is voice chat content which typically occurs between players during multiplayer and/or online gameplay.

“Properties of an audio output device” may include properties which identify the audio output device, for example, identify the type, model and/or connection means of an audio output device. “Properties of an audio output device” may also include audio characteristics of the audio output device such as such as frequency response, output power, maximum sound pressure level (SPL), sensitivity, quality factor, and total harmonic distortion (THD) which define the capability of the audio output device to reproduce an audio output effectively. These properties may be associated directly with the connected audio output device, or may be approximated properties of the connected audio output device.

“Selection criteria” may be defined as one or more rules which determine, for a given audio component, whether said audio component is to be selected for the adapted audio output. The selection criteria may be rules associated with properties of the audio components such as priority or frequency composition, and may include selection based on thresholds or a more complex determination generated by an algorithm or machine learning based model.

“A subset of the audio components” may be defined as a number of audio components less than or equal to the number of audio components in the received audio streams.

Typically, the subset of audio components comprises a number of audio components less than the number of audio components in the audio streams. This removal of audio components from the audio output allows audio output devices with lower audio reproduction capabilities to reproduce the selected audio components more effectively.

In some examples, each of the plurality of audio components are associated with a priority value, and generating an adapted audio output for the audio output device further comprises selecting a subset of the audio components based on the priority values.

A “priority value” is typically a numerical value associated with an audio component indicating either an absolute precedence of an audio component in relation to a pre-determined scale or a relative precedence of an audio component in relation to other audio components. In some examples, priority values may be tags assigned to in-game audio components during game development or may be determined in real-time during gameplay.

By generating an adapted audio output comprising a subset of the audio components additionally based on priority values, the adapted audio output can be tailored to output the highest priority audio components which are able to be effectively reproduced by the audio output device. This provides an improved user audio experience since higher priority sounds can be maintained in the adapted audio output.

To perform audio component selection based on priority values, the selection criteria preferably comprise a priority value threshold, wherein the threshold is based on the obtained properties of the audio output device. The use of a priority value threshold provides a simple mechanism to prevent certain audio components of low importance being selected for the adapted audio output so that higher priority sounds can be better reproduced by the audio output device. Typically, the threshold is relative to a highest priority value associated with the audio components in the audio stream.

In some examples, generating an adapted audio output for the audio output device further comprises selecting a subset of the audio components based on audio characteristics of the audio components.

“Audio characteristics” may refer to properties of the sounds stored as audio components such as their frequency composition and dynamic range, which may affect the ability of a given audio output device to reproduce them effectively.

Typically, audio characteristics of the audio components comprise a frequency composition of the audio components. A frequency composition of the audio components may be pre-stored in a memory of the video gaming system, or the audio components may be processed by the video gaming system to obtain a frequency composition. In some examples, a processing unit of the video gaming system may perform a Fourier transform of the audio components using a known algorithm such as the Fast Fourier transform (FFT) to obtain the frequency compositions.

The use of frequency compositions ensures that only audio components having a frequency composition that can be effectively reproduced by the audio output device will be selected in the adapted audio output. Those audio components having a high proportion of their frequency composition in frequency ranges which are difficult to reproduce, such as frequencies approaching the extremes of the audible hearing range, would not be selected if the audio output device is not capable of reproducing them effectively.

In some examples, the selection criteria comprise a frequency dependent intensity threshold, wherein the threshold is based on the obtained properties of the audio output device. As the threshold is based on a frequency composition of a given audio component, the frequency dependent intensity threshold can be used to prevent audio components which have a significant proportion of their frequency composition at a frequency or in frequency range which is not effectively reproduced by the audio output device from being selected for the adapted audio output. In this way, the adapted audio output will only include audio components which have frequency dependent intensities that will be effectively reproduced by the audio output device.

In some examples, the one or more properties of the audio output device comprise at least one of a category of audio output device, a model of audio output device, and a connection type between the video gaming system and audio output device.

A “category” of audio output device may be a broad grouping of devices such as loudspeakers or headphones, or may consist of narrower categories, e.g. separating headphones into in ear headphones and around ear headphones or loudspeakers into TV speakers and external speakers.

A “model” of an audio output device may be a more specific property than a category such as a brand, a version or serial number of an audio output device.

The “connection type” between the video gaming system may be labelled as wired/wireless or may relate to a more specific identifier such as an HDMI or Bluetooth connection. A connection type may affect the capability of the audio output device to reproduce audio output effectively (e.g. through bandwidth requirements) and therefore these examples provide a mechanism for the connection type to be accounted for in the generation of the adapted audio output.

Preferably, generating an adapted audio output for the audio output device further comprises accessing a profile associated with the obtained properties of the audio output device, the profile comprising a mapping between the obtained properties and audio component selection criteria.

“Profiles” may be data pre-programmed into files and stored in a memory of the video gaming system or accessed by the video gaming system from a remote memory over an internet connection. Profiles associated with properties of audio output devices are a convenient way to obtain selection criteria for common categories and models of audio output device requiring minimum additional information to be provided by the user.

The association of profiles with models of the audio output device enables the most suitable selection criteria to be obtained, resulting in the generation of a better optimised adapted audio output. Alternatively, through the association of profiles with a category of audio output device, audio characteristics common amongst audio output devices within a certain category maybe obtained without requiring a profile associated with a particular model of audio output device.

In some examples, the one or more properties of the audio output device comprise at least one of: frequency response, output power, maximum sound pressure level (SPL), sensitivity, quality factor, and total harmonic distortion (THD). In these examples, generating an adapted audio output for the audio output device may further comprise accessing a profile associated with the obtained properties of the audio output device, the profile comprising a mapping between the obtained properties and the selection criteria.

In examples where the obtained properties are frequency dependent, a profile may be associated with the audio output device through ranges of frequencies such as frequencies where the audio output device frequency response deviates from flat by a predetermined amount. For example, a profile may be associated with audio output devices having a response relative to frequency that deviates greater than-5 dB from flat in a range 20 Hz to 200 Hz, indicating that the audio output device cannot effectively reproduce low frequencies. Equivalent frequency dependent thresholds may be applied to output power, maximum sound pressure level (SPL), sensitivity, quality factor, and total harmonic distortion (THD).

In some examples, obtaining the one or more properties of the audio output device comprises detecting, by the video gaming system, the one or more properties of the audio output device. Direct detection of properties of the audio output device by the video gaming system provides a mechanism for the video gaming system to automatically identify the audio reproduction capabilities of a connected audio output device, therefore providing the most accurate information for use in the generation of optimised audio output. Furthermore, since this means of obtaining properties of the audio output device is automated, burden on the user is minimised. In these examples, the detecting may comprise sending, by the video gaming system, a message requesting information from the audio output device indicative of one or more properties of the audio output device; and receiving, by the video gaming system, information from the audio output device indicative of one or more properties of the audio output device.

In other examples, obtaining the one or more properties of the audio output device comprises receiving, by the video gaming system, user input indicative of one or more properties of the audio output device, providing a simple mechanism for the video gaming system to obtain properties of the audio output device. The user input may include selecting properties from pre-defined lists or specifying properties with text input. In these examples, it is not required that an audio output device supports communication with the video gaming system to identify one or more properties and therefore allows tailored audio output to be generated for wide range of audio output devices.

Preferably, the audio components are associated with audio categories comprising at least one of: voice chat, in-game music, in-game narration, in-game diegetic sounds; and generating an adapted audio output for the audio output device further comprises selecting only audio components associated with a subset of the audio categories. By omitting certain categories of audio components in the adapted audio output, audio components belonging to the subset of audio categories may be more effectively reproduced by the audio output device, thus improving the user experience.

In other examples, audio components associated with certain categories of audio may be prioritised over other categories of audio. For example, a voice chat stream or in-game dialogue/narration may be prioritised over in-game music such that the adapted audio output includes sufficient audio components so that the speech can be understood.

In some examples only audio components in the audio stream selected in generating an adapted audio output for the audio output device are processed by a processing unit of the video gaming system. This may include loading all audio components into the processing unit but not processing audio components not selected in generating the adapted audio output, or not loading into the processing unit audio components not selected in generating the adapted audio output. In this way, in addition to providing an improved auditory experience for the user, the processing requirements in generating audio output may be reduced.

In a second aspect of the invention there is provided a video gaming system wherein the video gaming system is configured to output an audio stream comprising a plurality of audio components, the video gaming system comprising: a processing unit configured to: obtain one or more properties of an audio output device; generate adapted audio output for the audio output device by selecting, according to selection criteria, a subset of the audio components based on the obtained properties of the audio output device; and an audio output interface configured to output only the selected audio components.

The video gaming system according to second aspect may additionally be configured to carry out the various implementations of the first aspect described above.

Advantageous effects associated with the second aspect are comparable to those described in relation to the first aspect.

### BRIEF DESCRIPTION OF DRAWINGS

FIG. 1 illustrates a method flow diagram of a method according to the present invention;

FIG. 2 illustrates a method flow diagram of a method according to the present invention;

FIG. 3 illustrates a method flow diagram of a method according to the present invention;

FIG. 4A illustrates a video gaming system according to the present invention;

FIG. 4B illustrates a video gaming system according to the present invention.

### DETAILED DESCRIPTION

Whilst modern video gaming systems often have high specification hardware enabling them to reproduce rich and immersive audio-visual content, the output devices used for viewing and listening to such content vary significantly between users and can have a significant impact on the user experience. Regarding the audio associated with this content, users may choose to listen to the content through a wide variety of different audio output devices depending on their preferences and environment. These may include, but are not limited to TV speakers, external speakers, portable speakers, in ear headphones, over ear headphones, headsets and the like. This wide variety in audio output devices means that audio reproduction quality and capabilities also can vary significantly between use cases. In some instances, when an audio output device of a low reproduction quality is used to listed to audio from the content, some components of the audio content may be reproduced having poor quality, distortion or in some cases being made inaudible.

The principle of the present invention is therefore for a video gaming system to generate audio output tailored to the audio output device that the user is using to listen to the auditory content. As described further below, this may be implemented in a number of different ways, but each allows for an improvement in the user's overall experience of the content.

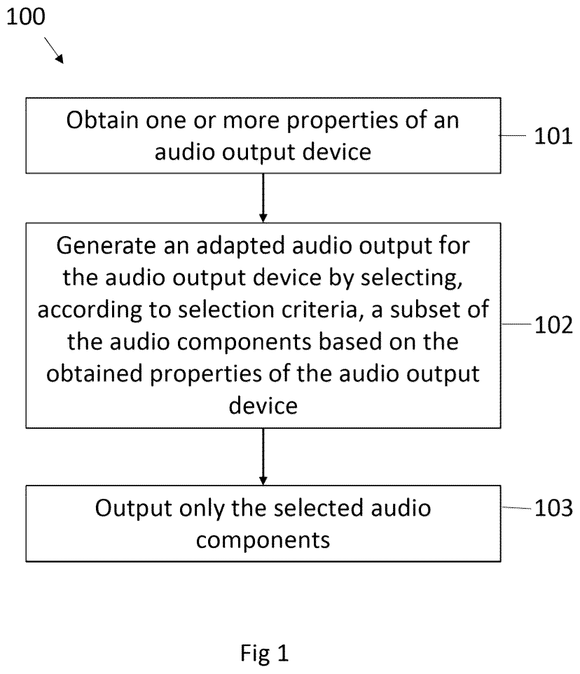

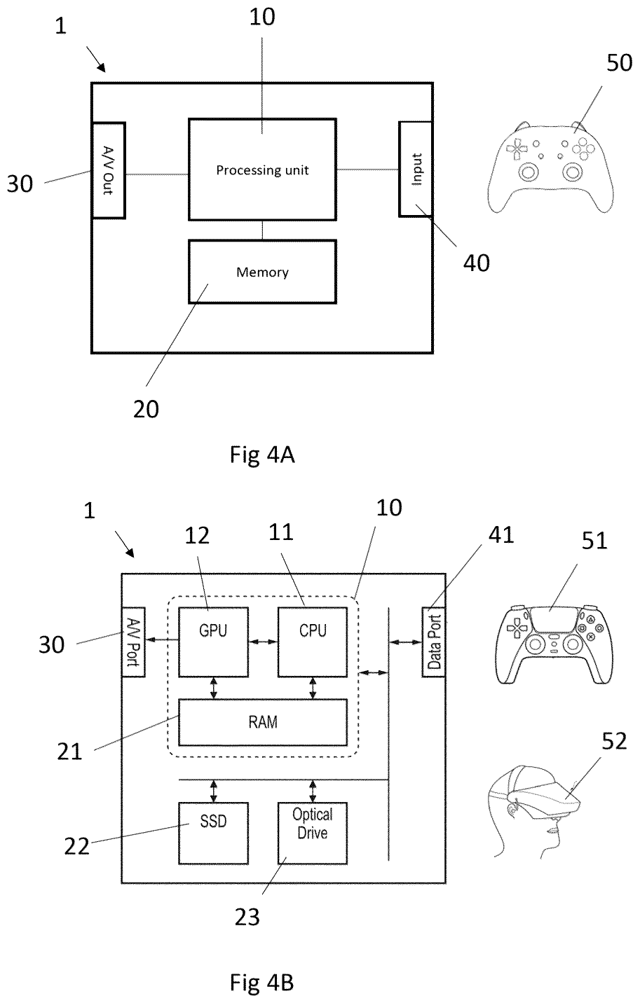

FIG. 1 schematically illustrates a method 100 for generating audio output by a video gaming system according to the present invention. The video gaming system may be a video gaming system 1 illustrated in FIGS. 4A and 4B.

FIG. 4A schematically illustrates a video gaming system 1 according to the present invention. The video games system 1 comprises a processing unit 10 configured to process and output audio components of the audio streams via the audio-visual output interface 30. The audio-visual interface 30 may comprise a physical port on the video games system 1 such as an HDMI or USB port, or may comprise a wireless interface such as a Bluetooth or Wi-Fi connection. The audio-visual output interface 30 may be a combined interface or consist of separate audio and visual connections.

In this example, the system 1 also comprises a local memory 20 which may be used to store audio data files for processing by the processing unit before being output as part of the adapted audio output.

The video gaming system 1 may further comprise an input 40 for receiving user input during gameplay. For example the input 40 may be connected to a controller 50, as illustrated in FIG. 4A. The input may comprise any number of input types, for example a disk drive, USB, Bluetooth, or a wireless or wired internet connection allowing the video gaming system to receive data.

After loading a video game and initiating gameplay, the video gaming system 1 outputs generated audio output and a visual output stream via the audio-visual output 30, by processing audio and graphical data files, or “assets”, with the processing unit 10. The audio-visual output 30 is connected to a display for displaying the visual output stream and an audio output device for outputting the generated audio output. The graphical and audio assets, i.e. graphic and audio data files, corresponding to the audio and visual components are stored in memory 20 locally or remotely, before being accessed and processed by the processor unit 10 to be deployed as part of the audio-visual output stream. In addition to the stored audio assets, audio generated in real time such as that originating from voice chat amongst users may also be deployed as part of the adapted audio output. Thus, the method illustrated in FIG. 1 may be performed by the processing unit 10 and may further comprise outputting the adapted audio output through the audio-visual output 30.

FIG. 4B schematically illustrates a further exemplary video gaming system on which the above-described methods may be implemented, where one or more of these features may be used within the general system described above. FIG. 4B illustrates a schematic diagram illustrating the Sony PlayStation 5 (PS5) architecture. The system 1 comprises a processing unit 10, which may be a single or multi core processor, for example comprising eight cores as in the PS5. The system 1 of FIG. 4B also comprises a graphical processing unit (GPU) 12. The GPU 12 can be physically separate to the CPU 11, or integrated with the CPU as a system-on-a-chip brackets (SoC) as in the PS5. The system one may have separate RAM 21 for each of the CPU and GPU or shared RAM as in the PS5. The RAM 21 can be physically separate or integrated as part of a SoC as in the PS5. Further memory may be provided by a disc 23, either as an external integrated hard drive, or as an external solid-state drive or internal solid state drive 22 as in the case of the PS5.

User input is typically provided using a handheld controller 51, such as the dual sense control in the case of the PS5. The system 1 may transmit or receive data by one or more data interfaces 41, such as a USB interface, ethernet interface, Wi-Fi interface or Bluetooth interface. As above the audio-visual output from the system 1 is typically provided through one or more AV ports 30, or may be streamed over the one or more data interfaces 41. The method illustrated in FIG. 1 may be implemented in the same way on the system of FIG. 4B. In this case, the method may additionally comprise outputting the adapted audio output through the one or more AV ports 30 or data interfaces 41. The stored audio data files may be stored locally in one of the memory components 21, 22, 23 or retrieved from an external storage through the data port 41. Voice chat audio may be received over the one or more data interfaces 101, typically using a VoIP protocol.

The system may include additional hardware such as a headset 52 with eye tracking wherein the data from the eye-tracking module of the headset 52 may be used as an additional input to determine the priority of audio components.

The method illustrated in FIG. 1 comprises a first step 101 of obtaining one or more properties of an audio output device, a second step 102 of generating an adapted audio output for the audio output device by selecting, according to selection criteria, a subset of the audio components based on the obtained properties of the audio output device, and the third step 103 of outputting only the selected audio components. The adapted audio output typically comprises a number of audio components less that the number of audio components in the received audio streams. In this way, less capable audio output devices can reproduce the most important sounds effectively, preserving the user experience.

The method illustrated in FIG. 1 may be triggered by a number of different events such as the booting of the video gaming system, connection of a new audio output device to the video gaming system, loading a game on the video gaming system, or when initiated by a user via user input.

In the first step 101, obtaining one or more properties of an audio output device is a procedure in which the video gaming system ascertains information pertaining to the audio reproduction capabilities of the connected audio output device. This is carried out by either obtaining properties which identify the audio output device or by directly obtaining audio characteristics of the audio output device.

The sound reproduction capability of a given audio output device is largely defined by audio characteristics of the device such as frequency response, output power, maximum sound pressure level (SPL), sensitivity, quality factor, and total harmonic distortion (THD). Such properties are typically specified by the manufacturer of the audio output device so that each audio output device of a certain model will conform, within tolerances, to those specifications. In this way, by obtaining properties identifying the audio output device, a reliable approximation of the audio reproduction capabilities of the audio output device can be inferred.

In some examples, the one or more properties of the audio output device may be obtained directly by the video gaming system. This mechanism may apply to audio output devices which connect digitally to the video gaming system, for example over an HDMI connection, an optical connection, a USB connection, or over a wireless connection such as Bluetooth or Wi-Fi.

Communications between the video gaming system and audio output device for this purpose may be implemented using a handshake between the video gaming system and the audio output device. In this process, the video gaming system and audio output device exchange a series of messages enabling the video gaming system to obtain the one or more properties of the audio output device.

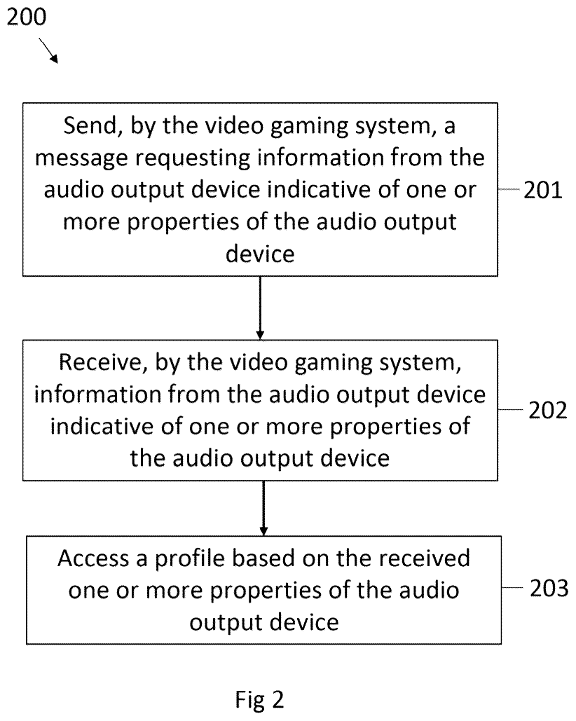

FIG. 2 provides an exemplary process by which properties of an audio output device are directly obtained by the video gaming system. In step 201, the video gaming system sends a message requesting information from the audio output device indicative of one or more properties of the audio output device. In step 202, the video gaming system then receives information from the audio output device indicative of one or more properties of the audio output device. In step 203, the video gaming system accesses a profile based on the received one or more properties of the audio output device.

Where an HDMI link is provided connecting the video gaming system and the audio output device, such communications may be implemented using the HDMI-CEC protocol.

In directly obtaining properties of the audio output device, the video gaming system may receive properties identifying the audio output device or may receive audio characteristics of the audio output device.

In other examples, particularly where two-way communications between the video gaming system and a connected audio output device is not supported, the one or more properties of the audio output device may be obtained via user input. In such examples, the video gaming system is configured to allow the user to provide information about the audio output device such as by selecting properties of the audio output device from entries in a list displayed by the video gaming system or inputting properties of the audio output device via text input.

In one example involving user input, the video gaming system is configured to provide a list including models of audio output device from which the user can select a matching model to the audio output device connected to the video gaming system to provide identification of the audio output device to the video gaming system. The list may also include entries for generic audio output devices which are not linked to a particular model of audio output device and are instead linked to a category and optionally a connection means of the audio output device. Some examples of generic devices are TV speakers, wireless soundbar, and Bluetooth earphones. A user may select a generic device if the list does not include an entry specific to the user's audio output device model. In some cases, common audio characteristics exist between audio output devices of the same category and/or connection means, therefore meaning that the video gaming system may still infer approximate audio reproduction capabilities of the audio output device.

In another example involving user input, the video gaming system is configured to allow a user to enter one or more audio characteristics of the audio output device. These may be obtained by the user, for example, by consulting the manufacturer's specifications of the audio output device. Audio characteristics obtained directly or through user input may be used directly to generate adapted audio output for the audio output device, may be compared to a database of audio output device audio characteristics to identify the audio output device, or may be used to access a profile as described in further detail below.

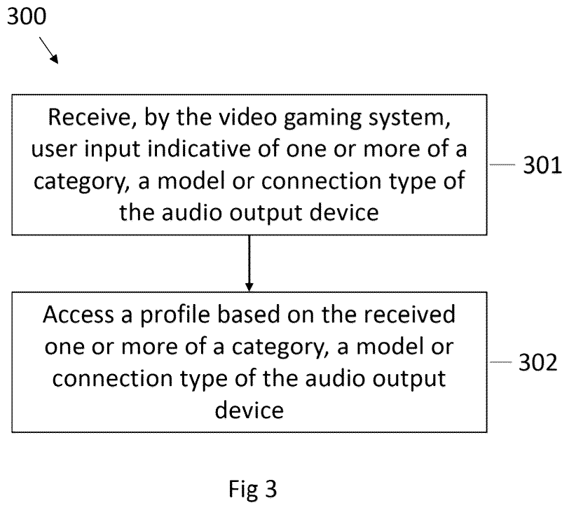

FIG. 3 provides an exemplary process by which properties of an audio output device are obtained by the video gaming system. In step 301, the video gaming system receives user input indicative of one or more of a category, a model or connection type of the audio output device. In step 302, the video gaming system accesses a profile based on the received one or more of a category, a model or connection type of the audio output device.

Once the video gaming system has obtained properties of the audio output device, the method advances to step 102, in which the video gaming system generates an adapted audio output for the audio output device by selecting, according to selection criteria, a subset of the audio components based on the obtained properties of the audio output device. This step is typically performed upon a user loading a game and beginning gameplay.

The audio components derive typically include stored audio data which may be associated with categories of audio. These may include non-diegetic sounds such as in-game music and diegetic sounds such as dialogue and sound effects, all of which may vary depending on events occurring as the gameplay progresses based on user inputs. Additionally, in situations such as online gaming, audio components may additionally include real-time audio data such as voice chat channels which enable users to interact with one another during gameplay.

For stored audio data, the audio components represent assets within the audio stream such as pieces of in-game music, snippets of dialogue from different characters or avatars, and sound effects originating from different in-game objects. For audio components generated in real time such as voice chat, the audio components may represent packets of audio received by the video gaming system.

The selection criteria determines whether a given audio component is selected to be included in the adapted audio output are based upon the obtained properties of the audio output device. The criteria may relate to a number of different properties of the audio components such as a level of priority or audio characteristics such as frequency composition, providing control over which audio components are included in adapted audio output for a given audio output device.

To obtain selection criteria, the video gaming system may use obtained properties of the audio output device to access a profile associated with the identified audio output device. Profiles accessible by the video gaming system may be pre-programmed files stored in a memory of the video gaming system or accessed by the video gaming system from a remote memory over an internet connection. Profiles indicate a mapping between audio output device properties and audio component selection criteria such that when an audio output device is identified by the video gaming system, selection criteria corresponding to that audio output device can be applied in generating adapted audio output.

In some examples, the selection criteria may include a predetermined threshold priority value. This is implemented so that only audio components with an associated priority value above the predetermined threshold are selected in generating the adapted audio output. The threshold may be a lowest absolute priority value or may represent a constraint on relative priority values such as a range of priority values below a highest priority value present in an audio stream. In further examples there may be a more complex selection criteria for selecting audio components associated with priority values to select when generating the adapted audio output. Stored audio components may be pre-tagged during game development with a priority value according to their deemed importance to the overall user experience. Alternatively, the priority of the audio components may also be assessed dynamically during gameplay as described in more detail below.

In one example, the priority of the audio components may be determined based on a distance of a virtual source of the audio component from the player character within the game environment. The “virtual source” is where the sound originates in the virtual world of the game and so is related to diegetic sounds. For example, sound effects associated with a non-player character nearer to player character may be assigned a higher priority than sound effects associated with a second nonplayer character within the game environment.

In another example, the priority of the audio components may be determined at least in part based on the number of similar audio components to the output within a threshold time period. For example, if there are a large number of bullets being fired during a battle sequence, where each gunshot is associated with a particular sound effect and the sound of each impact of a bullet on a surface is associated with a second sound effect, there will be a large number of sound effects to be output in a short space of time. In such situations, generating adapted audio output including additional background sounds likely not to be necessary to preserve the overall audio and user's enjoyment of the game, and on some lower capability audio output devices, may only act to impair the quality with which the battle sequence sound effects are represented to the user by the audio output device.

In a further example, the method may include the use of additional hardware to decide on a priority of the audio components. As shown in FIG. 4B, the video gaming system 1 may comprise additional input hardware, such as a headset 52 configured for user eye-tracking. The headset 52 may implement known methods to track the gaze of a user to identify which areas of the screen the user is looking at. With this input data, the system 1 may dynamically adapt the priority values associated with audio components. Audio components may be assigned a priority (at least in part) based on where the virtual source of the corresponding audio component is on the display of the screen relative to the location of the user's gaze. For example, if the user's gaze is detected to be at the location corresponding to a non-player character in a particular location of the screen, sound effects associated with that non-player character are assigned a higher priority than sound effects associated with non-player characters further from the location of the user's gaze. In a similar manner, if the user's gaze is detected to be at the location corresponding to a character of another online player in a particular location of the screen, voice chat audio components associated with that player are assigned a higher priority than voice chat audio components associated with other players further from the location of the user's gaze.

In this way, when users are listening on an audio output device of low capability, sounds deriving from locations closer to the user's gaze are preserved in the audio output, while audio components associated with sounds that are distanced from the location the user's gaze may be omitted from the audio output.

In further examples there may be a more complex method for determining priority based on one or more of the measures described above. In particular each audio component may have a priority score based on a formula incorporating one or more of the above distance of the location of the audio component from the player character, the type of audio component, a measure of the number of synchronous similar audio components being output and/or a determination of the distance from the location of the user's gaze.

Each audio component may be associated with a priority value through individual assignment in a one-to-one fashion, or a group of audio components belonging to a category may be associated with a common priority value. For example, all audio components associated with in-game music may be associated with a common priority value. In some examples, all audio components associated with voice chat may be associated with a common priority value, or audio components originating from the voice chat channel of the same player may be associated with a common priority value.

In some examples, audio components are selected in generating adapted audio output based on audio characteristics of the audio components. Audio characteristics such as frequency composition may vary greatly between audio components originating from different physical and virtual sources, with some components having frequency compositions which are difficult for lower capability audio output devices to reproduce effectively.

For example, background sound effects involving explosions may contain a large proportion of their audio frequency composition in a low frequency range (20 Hz-200 Hz). Many lower quality or portable audio output devices struggle to reproduce low frequencies effectively and attempting to reproduce these audio components can have a negative impact on the auditory experience.

To rectify this problem, selection criteria may be configured to drop audio components which have a large proportion of their frequency composition in a frequency range that is not effectively reproduced by the audio output device. In some examples, this is performed by analysing the frequency composition of an audio component and comparing that composition to a frequency dependent intensity threshold stored in selection criteria associated with the audio output device.

Whereas the frequency composition of stored audio components may be provided in advance, i.e. generated during game development, the analysis may also be performed at runtime. For a stored audio component comprising an audio asset stored as a file, a frequency composition may be obtained by applying a Fourier transform to the data stored in the file and identifying the intensity spectrum of different frequencies within that audio component. Such an analysis may be performed using known algorithmic techniques such as the fast Fourier transform.

Once an audio component frequency composition has been obtained, the selection criteria is applied to determine whether the audio component should be included in the adapted audio output. Selection criteria associated with the audio output device in these examples may be a frequency dependent intensity threshold, which limits a maximum intensity at a given frequency. If the intensity in the frequency composition at a given frequency is greater than the intensity threshold at that frequency, the audio component would not be selected for the adapted audio output. The frequency dependent intensity threshold is tailored to the audio output device ensuring that only audio components that would be effectively reproduced are selected for the adapted audio output.

In some examples, the selection criteria are based on a combination of audio characteristics and priority value such that only the highest priority audio components that have audio characteristics meaning they can be effectively reproduced by the audio output device are selected when generating the adapted audio output. For example, a priority value threshold may first be applied to discard low priority audio components and then a frequency dependent intensity threshold may be applied to discard the remaining audio components which would not be effectively reproduced by the audio output device. It should be understood that the application of these thresholds may also be performed in the opposite order.

The selection criteria may also take into account the category of audio to which the audio component belongs. For example, the audio components are associated with audio categories comprising at least one of: voice chat, in-game music, in-game narration, in-game diegetic sounds; and generating an adapted audio output for the audio output device further comprises selecting only audio components associated with a subset of the audio categories.

Once the subset of audio components for inclusion the adapted audio output have been selected, the method progressed to step 103 where only the selected components are output to the audio output device to preserve the auditory experience of the user. In generating the adapted audio output, the audio components which are not selected for inclusion in the adapted audio output may be dropped by the processing unit of the video gaming system. Dropping of the audio components may occur after they have been loaded into the processing unit prior to being processed, or before being loaded into the processing unit such that processing resources are not wasted processing audio components that have not been selected for inclusion in the adapted audio output.

1. A method of generating audio output by a video gaming system, wherein the video gaming system is configured to output an audio stream comprising a plurality of audio components, the method comprising:
obtaining one or more properties of an audio output device connected to the video gaming system;
generating an adapted audio output for the audio output device by selecting, according to selection criteria, a subset of the audio components based on the obtained properties of the audio output device; and
outputting the selected subset of audio components.

2. The method according to claim 1, wherein each of the plurality of audio components corresponds to an audio asset.

3. The method according to claim 1, wherein the subset of audio components comprises a number of audio components less than a number of audio components in the audio stream.

4. The method according to claim 1, wherein:
each of the plurality of audio components are associated with a priority value; and
generating the adapted audio output for the audio output device further comprises selecting the subset of the audio components based on the priority values.

5. The method according to claim 4, wherein the selection criteria comprise a priority value threshold, wherein the threshold is based on the obtained properties of the audio output device.

6. The method according to claim 5, wherein the threshold is relative to a highest priority value associated with the audio components in the audio stream.

7. The method according to claim 1, wherein generating the adapted audio output for the audio output device further comprises selecting the subset of the audio components based on audio characteristics of the audio components.

8. The method according to claim 7, wherein audio characteristics of the audio components comprise a frequency composition of the audio components.

9. The method according to claim 8, wherein the selection criteria comprise a frequency dependent intensity threshold, wherein the threshold is based on the obtained properties of the audio output device.

10. The method according to claim 1, wherein the one or more properties of the audio output device comprise at least one of a category of the audio output device, a model of the audio output device, or a connection type between the video gaming system and the audio output device.

11. The method according to claim 10, wherein generating the adapted audio output for the audio output device further comprises accessing a profile associated with the obtained properties of the audio output device, the profile comprising a mapping between the obtained properties and the selection criteria.

12. The method according to claim 1, wherein the one or more properties of the audio output device comprise at least one of frequency response, output power, maximum sound pressure level (SPL), sensitivity, quality factor, or total harmonic distortion (THD).

13. The method according to claim 12, wherein generating the adapted audio output for the audio output device further comprises accessing a profile associated with the obtained properties of the audio output device, the profile comprising a mapping between the obtained properties and the selection criteria.

14. The method according to claim 1, wherein obtaining the one or more properties of the audio output device comprises detecting, by the video gaming system, the one or more properties of the audio output device.

15. The method of claim 14, wherein the detecting comprises:
sending, by the video gaming system, a message requesting information from the audio output device indicative of one or more properties of the audio output device; and
receiving, by the video gaming system, information from the audio output device indicative of one or more properties of the audio output device.

16. The method according to claim 1, wherein obtaining the one or more properties of the audio output device comprises receiving, by the video gaming system, user input indicative of one or more properties of the audio output device.

17. The method according to claim 1, wherein:
the audio components are associated with audio categories comprising at least one of voice chat, in-game music, in-game narration, or in-game diegetic sounds; and
generating the adapted audio output for the audio output device further comprises selecting audio components associated with a subset of the audio categories.

18. The method according to claim 1, wherein audio components in the audio stream selected in generating the adapted audio output for the audio output device are processed by a processing unit of the video gaming system.

19. A video gaming system, wherein the video gaming system is configured to output an audio stream comprising a plurality of audio components, the video gaming system comprising:
a processing unit configured to:
obtain one or more properties of an audio output device; and
generate adapted audio output for the audio output device by selecting, according to selection criteria, a subset of the audio components based on the obtained properties of the audio output device; and
an audio output interface configured to output the subset of the audio components.

20. The video gaming system according to claim 19, wherein each audio component corresponds to an audio asset.
